(19) United States
(12) Patent Application Publication
(10) Pub. No.: US 2011/0095458 A1
(43) Pub. Date: Apr. 28, 2011

(54) ELASTOMERIC SLEEVE MOUNT WITH HYDRAULIC DAMPING

(75) Inventor: Michael Schmitz, Bonn (DE)

(73) Assignee: ZF FRIEDRICHSHAFEN AG, Friedrichshafen (DE)

(21) Appl. No.: 12/673,182

(22) PCT Filed: Jul. 30, 2008
(86) PCT No.: PCT/DE08/50016

§ 371 Date: Feb. 12, 2010

(30) Foreign Application Priority Data
Aug. 14, 2007 (DE) 10 2007 038 493.0

(51) Int. Cl. F16F 13/14

(52) U.S. Cl. 267/140.12

(57) ABSTRACT

An elastomeric bushing with hydraulic damping in which the swell walls (5, 5′), which limit the swell cavities (4, 4′) and ensure a high permanent durability of the bushing, are linked to the other parts of the bushing body (2) in a special manner. The swell walls (5, 5′) are linked to the bars (6, 6′) only in a radial outer area, but are otherwise not connected therewith. The outer sleeve (3) and the connected bushing body (2) form, via vulcanization process, a separate part into which the inner part (1, 1′) is inserted. Opposed ends of the inner part (1) each have an overhang (9, 9′) which engage with the bar plates (8, 8′), vulcanized into the bars (6, 6′) of the bushing body (2), and the bars (6, 6′).

This application is a National Stage completion of PCT/DE2008/050016 filed Jul. 30, 2008, which claims priority from German patent application serial no. 10 2007 038 493.0 filed Aug. 14, 2007.

### FIELD OF THE INVENTION

The invention relates to an elastomeric bushing with hydraulic damping, particularly a hydro bushing. It refers to a genus of an elastomeric bushing with at least a pair of actively performing work cavities, meaning swell cavities equipped with a pump action, which have limiting swell walls, to guarantee a high permanent durability of the bushing and are attached, in a special manner, to the other parts of the bushing body.

### BACKGROUND OF THE INVENTION

It is known to equip an elastomeric bushing with a hydraulic damping, especially for the use in the automotive industry, for bearing of components at the chassis. Related bearings comprise of a tube or cylinder shape, often with a metallic inner part, surrounding that inner part either concentric or eccentric, also in general a metallic outer sleeve, as well as an elastomeric bushing body positioned between the inner part and the outer sleeve. To support the damping behavior of the bushing body, a hydraulic system is provided which comprises of at least a pair of configured cavities, in the bushing body or between the bushing body and the outer sleeve, to accept a fluid damping material and having at least one connecting passage to these cavities. In relationship to the circumferential direction, the cavities are spatially separated, due to bars of elastomeric bushing body, positioned between the inner part and the outer sleeve. They are also limited by capsules, in the axial direction, which are axial positioned and extending in the axial direction into the inner of the bushing, of which they are separated, by the cavity walls, extending from the inner of the bushing axial, as well as bulged, to the outside. The cavities, which except the damping material, are called swell cavities and the limiting walls are called swell walls, whereby the bulging swell walls provide the cavities with a pump effect through which, in case of a radial acting load in the cavity, the present damping material of the particular swell cavity is pumped, via the passage, into the other respective swell cavity. Hereby, due to the bulging of the swell walls, a long deforming distance is given, favoring the permanent durability of the bushing, and in a large radial, in the form of shock impacts to the bushing, the acting forces can guarantee a lower dynamic hardening of the elastomer of the bushing. Hydro bushings in the described art are known, for example, through DE 38 18 287 A1 and the DE 102 13 627 A1.

However, it has been shown that by larger radial loads, which result in larger deforming travel, and in a practical application, simultaneously occurring strong torque loads, the permanent durability of the bushing is reduced. Hereby, radial loads, if they are overlaid by large rotation angles, caused at the bushing body, generate permanent durability problems especially in the area of the link of the swell walls to the other parts of the bushing body. Especially critical hereby is the connection of the swell walls in the area of the designed passage into the bushing body and its vulcanized passage carrier part. Here, cracks can occur and the damping material can possibly escape from the cavities through them.

The cavity wall pressure can be reduced if these walls, compared to the other areas of the bushing body, are at least partially exempt, meaning linked only selectively to the bushing body, so that even larger deforming travel can occur. For instance, a hydro bushing is known by EP 0 600 358 A2 in which a cavity is designed as a free hanging cavity, meaning the swell wall is only partially attached. The bushing which is described in this publication, however, has a passive cavity, not designed as a swell cavity, which just serves to accommodate damping material, displaced by the active, opposite cavity, but which is not equipped with a pump function. An especially effective support of the damping through the fluid damping is, however, only achieved through active cavities equipped with a pump function. Therefore, the damping, described in the previous publication, only supports radial forces which affect cavities in the circumferential area equipped with a pump function. To support also, via the hydraulic system, a circumferential area opposite an active cavity, it would be required, in accordance with the publication, to provide an additional cavity pair with an active cavity in the respective circumferential area.

It was also shown that a partial exempt of the cavity walls will reduce the load in the connection to the bushing body, however, but the bars of the bushing body still remain critical when running constantly.

### SUMMARY OF THE INVENTION

Therefore, it is the task of this invention to create a hydro bushing in a way so that its load on the material, in the area of the link between the cavity walls and the bushing body, in the case of large radial forces overlaid by strong torque forces, will be reduced and, at the same time, improving the permanent durability of the bars.

The proposed elastomeric bushing for solving the task comprises, as already known, of a tube or cylinder shaped preferably metallic inner part, an outer sleeve which surrounds the inner part, and an elastomeric bushing body located between the inner part and the outer sleeve. Hereby, the bushing body in the outer sleeve can be positioned either concentric or eccentric with regard to the inner part. For the realization of a hydraulic damping, the bushing comprises of a pair of swell cavities, in the bushing body or between its outer contour in the outer sleeve, to accommodate a fluid damping material. The swell cavities are, within regard to the bushing circumferential direction, positioned in an offset in spatially separated, through designed bars of the bushing body, between the inner part and the outer sleeve. They perform as active work cavities which will pump the damping material, in the case of a radial force affecting them, through at least one passage, connecting the cavities, into the other respective swell cavity. Hereby, the walls of the swell cavities are shaped as swell walls, bulged to the outside, which extend radial and axial from the bushing inner section to the outside. The swell walls, in the proposed bushing, are only attached to the bars in a radial outer area, but exempt along their remaining course, in relationship to the bars in the inner part of the bushing. As a result, based on the bulged shape, large deforming distances in the swell walls exist, also known in the state of the art for bushings, but whereby the invented exemption of the swell walls accomplishes that the bushing also, in case of radial loads and a simultaneously occurring torque stress, does not get damaged. In fact, in the case of large steering deflection, the stressed swell wall mainly experiences bending, while the opposite wall is almost load free because the inner part does not “pull it” (there is no connection between swell wall and the inner part). Therefore, and in accordance with that invented embodiment of the bushing, pull forces are not affecting the swell walls and there is no danger that the bushing body is torn apart, in that case of an overlay of radial and torque stress in the link area at the swell walls with the bars. It is hereby guaranteed that an unwanted leakage of the damping material is prevented. In addition, the free hanging swell wall areas counter-react well to a dynamic high hardening of the bushing body. The accordingly designed bushing hereby possesses a large permanent durability and good dynamic characteristics.

To achieve additional improvements for permanent durability in the area of the bars, the invented bushing is designed in a way so that its outer sleeve and bushing body, linked via vulcanization with the outer sleeve, including the bars and its connected swell walls in the radial outer area form a separate part. The inner part is inserted, in accordance with the invention, into this separate part designed as rubber-metal-part. The inner part has a larger boundary, in comparison to the rubber-metal-part inner absorbing geometry. In addition, the axial ends of the inner part are designed to have overhangs, directed radial to the outside. These overhangs, after the insertion of the inner part into the rubber-metal-part, formed by the holder sleeve and the bushing body, are engaged by bar plates from behind, which are vulcanized into the bars and lie inside. Hereby, via its vulcanized bar plates with a pre-load, the bars are provided in an advantageous way, based on the already mentioned larger boundary of the inner part, thereby improving the permanent durability. In regard to the passage, which connects the swell cavities with each other, a passage carrier part is preferably vulcanized into the radial outer area of the bushing body, meaning in the area of the link of the swell walls to the cavities, bordering the bar. This passage carrier part forms a protection, at the same time, for the bushing body.

In accordance with a possible embodiment of the invented bushing, the inner part, with regard to its axial extension, is designed as a two-piece part. In this embodiment, both parts of the inner part are axially inserted into the rubber-metal-part at each of the opposite end of the bushing whereby a final form closure, between the parts as well as the overhangs of the inner part and the bar plates, only take place when the bushing is mounted at its intended position, preferably fastened by means of a screw through the inner part. In another advantageous and evolving version of the embodiment is the material, which forms the overhang of the inner part, again folded back, radial inside, against the bar plates, on the axial inner side of the respective overhang, and preferably at approximately 180°. Hereby, an additional radial fixing is accomplished for the bar plates. A radial fixing of the bar plates in this manner, however, can only be done with bushings, which have a two-piece inner part, because such a one-piece designed in a part can barely be inserted into the rubber-metal-part formed by the bushing body in the outer sleeve. For instance, the inner part can be bent, to form the overhangs which axially fix the bar plates, axial and on both sides several times, first meaning radial to the outside and then axial to the inside (meaning into the direction of the inner section of the bushing), and be finally bent radial to the inside. For bushings, having a one-piece inner part, only a similar embodiment can be applied, in which just the overhang, on one axial side of the inner part is folded back in the described manner, and, therefore, the bar plates are only radial fixed at one axial side.

Praxis oriented embodiments of the invented bushing are also equipped with radial stops, which are located in the capsules which axially limit the cavities on both sides. Through these radial stops, the radial deformation, in the area of the swell cavities of the bushing body, is limited to protect against overloads. Hereby, the maximum, radial deformation travel is determined by the height, in which the radial stops rise against the outer sleeve, in the radial direction of the inner part. In the case of a small height for the radial stops, they can be designed as an integral part of the inner part because the constructive design of the bushing also allows the insertion of a one-piece inner part into the rubber-metal-part and passing the bar plates, by creating the pre-load for the bars, particularly with flat radial stops. If the maximum allowed, radial deformation distance needs to be limited by higher rising radial stops, in this case the radial stops are constructed preferably as separate parts which slide on the inner part from the axial ends of the bushing. Hereby, the parts, sliding from the axial end on the inner part, can be rings made from plastic, metal, or plastic or metal with a rubber overmold. Especially in bushings with a one-piece inner part, the axial fixing of the bar plates can also hereby take place without an additional folding back of the overhangs, which are part of the inner part at the axial ends, by means of stop rings.

Beside the passage, which serves to connect the swell cavities and therefore as support for the damping effect, that bushing can also be equipped with a short passage functioning as a bypass for the first mentioned passage, whereby the particular bypass passage, under normal operation of the bushing, is blocked via an inner blocking part and which opens briefly only when high radial loads occur. Basically, such a bypass passage can be waived in the proposed bushing configuration, since brief, high loads can be compensated by the flexibility of the free hanging swell wall. For special applications, however, a bypass passage can still be provided, whereby it can be dimensioned, or the blocking part in it, that high loads result with a flexibility, step-by-step, first through the free hanging swell wall and followed by releasing the bypass passage. For coordination or adjustment, respectively, of the radial stiffness behavior of the bars, these bars can have additional bar plates vulcanized into them. The invented bushing is advantageously constructed by the design of the bars, in the area of connecting the cavity walls with regard to the circumferential direction, are smaller, meaning that they are tailor shaped. Hereby, the permanent duration of the bushing, in the area of connecting the swell walls, also has been improved.

In an advantageous construction of the invented bushing, a radial shaping of the bushing body, rising to the outside, is provided and located in a bottom section of the cavities, meaning in a preferably axial centered inner area. The positioning of such nipples or pimples, respectively, serves to simplify mounting, especially insertion of the inner part into the rubber-metal-part. It is hereby possible to pull, temporarily and during assembly, the bottom section of the cavities, meaning the respective area of their swell walls by means of the nipples, to the outside for making the insertion of the inner part easier.

### BRIEF DESCRIPTION OF THE DRAWINGS

The invention will be explained further based on an embodiment. The corresponding drawings show:

FIG. 1: a possible embodiment of the invented bushing in a radial cross sectional presentation;

FIG. 2: is a bushing as in FIG. 1 having a two-piece inner part, and an axial cross sectional through the bar;

FIG. 3: is the bushing in accordance with FIG. 1 and FIG. 2, with an axial cross sectional through the cavities; and

FIG. 4: a generic bushing as in the state of the art.

### DETAILED DESCRIPTION OF THE PREFERRED EMBODIMENTS

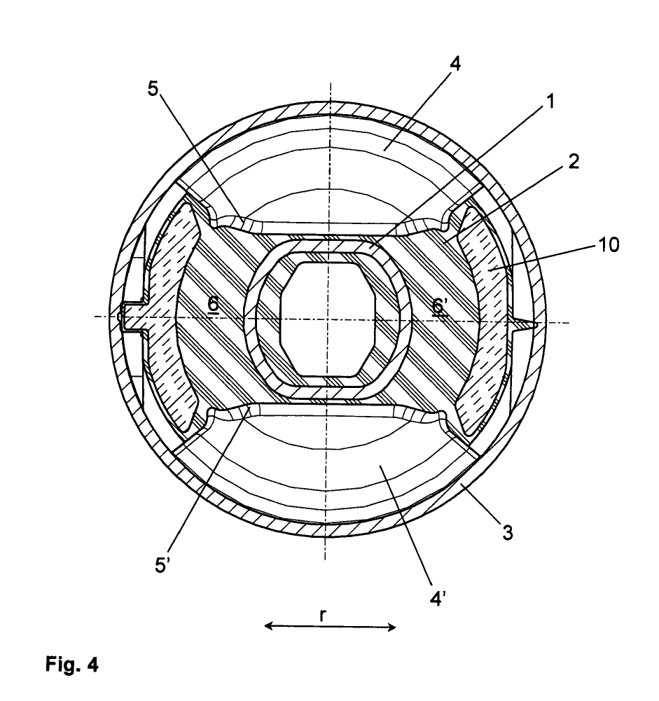

For the purpose of explanation, the focus here is toward a generic bushing, as in FIG. 4, and a typical embodiment of such embodiment as the state of the art. The presented bushing or hydraulic bushing, respectively, comprises a metallic inner part 1 basically of a tubular shape, an outer sleeve 3 and an elastomeric bushing body 2 positioned in between in which the swell cavities 4, 4′ reside for the damping purposes. The bushing body 2 presents a bearing spring, especially for applied radial forces, for which the outer sleeve 3 represents a supporting protection. The genus bearing as the bushing body 2 is, different from the invented bushing, connected mostly with the inner part 1 via vulcanization. The two constructed swell cavities 4, 4′, in the elastomeric bushing body 2, are connected via a passage, but not shown here. At least parts of this passage are encapsulated in a passage carrier 10, which is embedded into the bushing body 2 and, at the same time, provides additional protection for the bushing body 2. The inner part 1 and the outer sleeve 3 preferably comprise a metallic material, while the passage carrier part 10 can selectively be either metal or plastic. Also capsules, not shown here, are embodied in the elastomeric bushing body 2 axially above and below the cavities 4, 4′ which, in the axial direction, reach into the inner part of the bushing and which is separated from the swell cavities 4, 4′ by vaulted swell walls 5, 5′. The swell walls 5, 5′ of the swell cavities 4, 4′ are, along their entire length attached to the bars 6, 6′ or, at their radial outer area, to the passage carrier 10 by the corresponding bar 6, 6′. In this area of attachment, and at high radial load, especially when these loads are paired with high torque, a large additional tension will occur followed by problems with permanent durability.

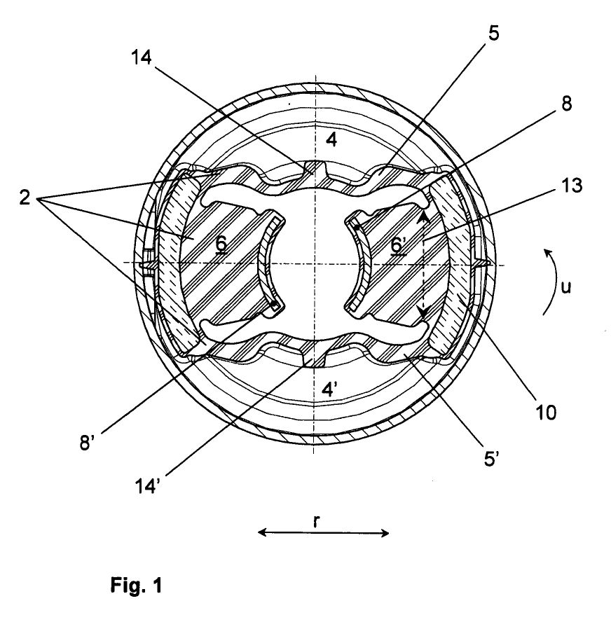

FIG. 1 shows, in a radial sectional presentation, one possible embodiment of the invented bushing whereby the bushing is presented before insertion of the inner part 1. Therefore, the drawing presents the rubber-metal-part 2, 3, derived from the elastomeric bushing body 2 and the outer sleeve 3 connected, by vulcanization, to accommodate the inner part 1. In this context, as also described in other areas of the specification, the rubber-metal-part 2, 3 is mentioned, although the invention is not limited to the use of rubber for the bushing as other elastomeric material can also be utilized. One can easily recognize, from the drawing, that the related shapes of the bushing and its swell chambers 4, 4′, as well as these swell cavities 4, 4′, related to their circumferential direction, are separated spatially from each other by the bars 6, 6′. The limits for the cavities 4, 4′ are established by the out of shape of the bushing 2, the swell walls 5, 5′ and the inner area of the outer sleeve 3.

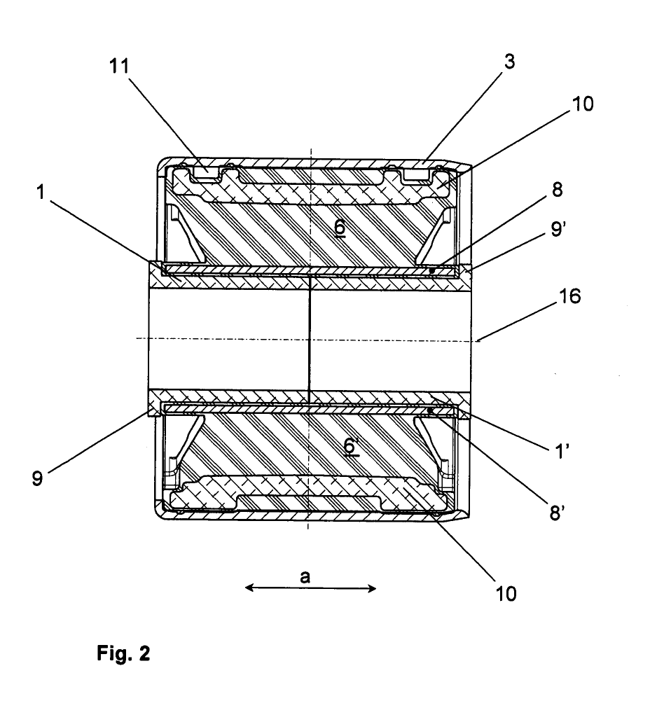

In view of the targeted increase with regard to permanent durability of the swell walls 5, 5′, also for large possibly torque overlay loads, the swell walls 5, 5′ are mostly exempted, so that the swell walls 4, 4′ can also be labeled as free hanging swell walls 4, 4′. As one can see from the drawing, the swell walls 5, 5′ are only linked to the bars 6, 6′ in a radial outer area, but otherwise are exempted as well as to the inner part 1. The bushing body 2, in the area of the link with the swell walls 5, 5′ and the bars 6, 6′, has a vulcanized protection part which embodies a passage carrier 10, for the linking passage 11 and the swell cavities 4, 4′. Following the basic idea of this invention, bar plates 8, 8′ are vulcanized into the bars 6, 6′, and their functionality will be explained further in connection with the following explanation of FIG. 2. In the presented embodiment of the invented bushing, a nipple or a pimple 14, 14′, respectively, is attached to the bushing body 2, in a center area, in relation to a circumferential direction of the swell chambers 4, 4′, meaning in a bottom section 15, 15′. Via the nipples 14, 14′, the swell walls 5, 5′, when inserting the inner part 1, can be pulled radial to the outer side thereby easing insertion of the inner part 1. In the area of the links of the swell walls 5, 5′, the bars 6, 6′ have a tailored shape 13 as also can be seen in the drawing. Hereby, the permanent durability of the bushing is further increased, in this area, or the risk of a crack in the elastomer of the bushing body 2 is further reduced.

In the FIG. 2, the bushing, in accordance with FIG. 1, is presented in an axial cross section, whereby the cross section proceeds through, parallel to or along, respectively, the bushing axle 16 through the bars 6, 6′ of the bushing body 2. The presentation shows the bushing following insertion of the preferably metallic inner part 1, 1′. The presented embodiment is a configuration of an axial, two-piece inner part 1, 1′. The two parts or segments, respectively, of the inner part 1, 1′ are inserted, in this embodiment and during the assembly of the bushing, both positioned and axial located into the rubber-metallic-part 2, 3. In accordance with this invention, the inner part 1, 1′ or its segments, respectively, each have an overhang 9, 9′ on the outside at the axial ends. When inserting the inner part 1, 1′ or its segments, respectively, into the rubber-metal-part 2, 3, the bar plates 8, 8′, vulcanized into the bars 6, 6′ of the bushing, latch in behind these overhangs 9, 9′ and fix the inner part 1, 1′ with regard to its axial position compared to the rubber-metal-part 2, 3. The inner part 1, 1′ is also designed larger than the rubber-metal-part 2, 3, as compared to FIG. 1, especially compared to the bars 6, 6′. Hereby, when inserting the inner parts above the bars 6, 6′, a pre-load is given to the bars 6, 6′, which leads to an increase of durability, or permanent durability, respectively, of the bushing body 2 in the area of the bars 6, 6′. One can also see, in the drawing, the vulcanized protection elements inserted radial into the outer areas of the bars 6, 6′ are designed, as previously mentioned, as a passage carrier 10 for the passage 11 connecting the swell cavities 4, 4′.

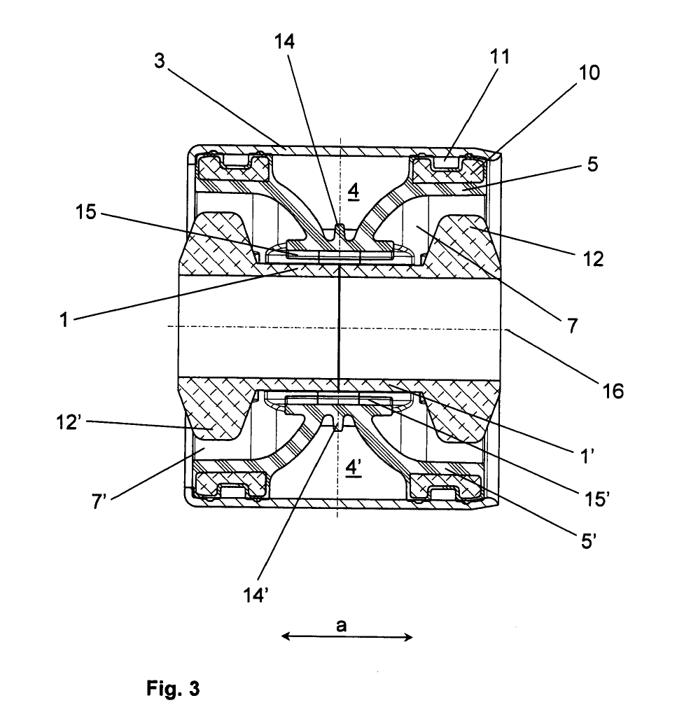

In FIG. 3, the previously described embodiment of the invented bushing, in an axial cross sectional presentation, is again shown whereby here the cross section proceeds parallel to or along, respectively, the bushing axle 16 and through the swell cavities 4, 4′. The drawing presents the structure of the swell cavities 4, 4′ especially well, opposite to the axial capsules 7, 7′, mounted on both sides of the limiting swell walls 5, 5′. The swell walls 5, 5′ extend from the inside of the bushing radial and axial to the outside in an vault like shape. It can also be seen that in the explanations of FIGS. 1 and 2, the already mentioned protection part which, in sections is configured as the passage carrier 11 for the passage 10, also extends through the bushing body 2, but it is cut out in the area of the swell cavities 4, 4′. The two-piece configuration of the inner part 1, 1′ is also shown in FIG. 2. It can also be seen that through a certain shaping at the axial ends of the inner part 1, 1′, in the area of the capsules 7, 7′, radial stops 12, 12′ are provided which prevent deformation of the swell walls 5, 5′ and, therefore, hereby protect the swell cavities 4, 4′ from overload. Hereby, the height of concavity of the radial stops 12, 12′ is dependent on the particular application and the layout of the bushing. If the radial stops 12, 12′ have a smaller height than shown here in the example, it is also possible to configure the inner part 1, 1′ as a single part and to insert the axial end of the bushing into the rubber-metal-part 2, 3. Hereby, as already explained in FIG. 1, insertion of the inner part 1, 1′ is supported by a radial expansion of the swell walls 5, 5′ to the outside by the configured nipples 14, 14′ at the bottom section 15, 15′. A single piece configuration of the inner part 1, 1′ is also possible if the radial stops 12, 12′ are added, by means of a separate part, to the inner part at the end of the bushing.

### REFERENCE CHARACTER LIST

1, 1′ Inner Part
2 Bushing Body
3 Outer Sleeve
4, 4′ Swell Chamber
5, 5′ Swell Wall
6, 6′ Bar
7, 7′ Capsule
8, 8′ Bar Plate
9, 9′ Overhang
10 Passage Carrier
11 Passage
12, 12′ Radial Stop
13 Tailored Shape
14, 14′ Nipple
15, 15′ Bottom Section or Cavity Bottom, respectively
16 Bearing Axle
a axial direction
r radial direction
u circumferential direction

1-12. (canceled)

13. An elastomeric bushing with hydraulic damping having an inner part (1, 1′), an outer sleeve (3) surrounding the inner part (1, 1′), an elastomeric bushing body (2) positioned between the inner part (1, 1′) and the outer sleeve (3), at least a pair of swell cavities (4, 4″) being formed between an outer contour of the bushing body (2) and the outer sleeve (3), the pair of swell cavities (4, 4″) being offset from one another with regard to a circumferential direction (u) to accept a damping fluid which flows as the cavities work and pump the damping material, via pressure forces in a radial direction (r), via at least one of connecting passage (11) into the other respective swell cavity (4 or 4′) whereby the swell cavities (4, 4′) are spatially separated from one another, in a circumferential direction (u), by the configured bars (6, 6′) of the bushing body (2), positioned between the inner part (1, 1′) and the outer sleeve (3), and limited, on both sides, axially by the capsules (7, 7′) extending from axial ends of the bushing ends, in the axial direction (a) into the bushing, from which the capsules (7, 7′) are separated by the swell walls (5, 5′) which extending in a vaulted manner radial and axial,
wherein the swell walls (5, 5′) are only attached to the bars (6, 6′) in a radial outer area, but apart from that are free from the bars (6, 6′) and the inner part (1, 1′), whereby the outer sleeve (3) and its vulcanization connected the bushing body (2) form a separate part in which the inner part (1, 1′) is inserted, the inner part (1, 1′) has an overhang (9, 9′) at each axial ends face thereof so that the overhangs (9, 9′) of the inner part (1, 1′) engages with the bar plates (8, 8′), vulcanized into the bars (6, 6′) of the bushing body (2) from behind, and the bars (6, 6′) being pre-loaded by the bar plates (8, 8′) by a designed excessive length of the inner part (1, 1′).

14. The elastomeric bushing according to claim 13, wherein the inner part (1, 1′) is designed as pair of axial pieces.

15. The elastomeric bushing according to claim 14, wherein the material which forms the overhang (9, 9′) of the inner part (1, 1′) is folded back toward a radial inside, against the bar plates (8, 8′) at an axial inner side of each overhang (9, 9′).

16. The elastomeric bushing according to claim 13, wherein radial stops (12, 12′) are positioned in the capsules (7, 7′), whereby these are designed as an integral part of the inner part (1, 1′), through its elevation or bulging at its axial ends, radial to the outside.

17. The elastomeric bushing according to claim 13, wherein a ring of either a plastic or a metallic material is slid on the axial ends of the inner part (1, 1′),

18. The elastomeric bushing according to claim 13, wherein a ring which comprises one of an elastomer, a plastic with added elastomer and a metal, is slid on the axial ends of the inner part (1, 1′) to form the axial stops (12, 12′) which are positioned in the capsules (7, 7′).

19. The elastomeric bushing according to claim 13, wherein the passage (11), serving as protection and connecting the swell cavities (4, 4′), is formed in a passage carrier (10) vulcanized in the bushing body (2), whereby the swell walls and (5, 5′), in the area of passage carrier (10), are linked to the bars (6, 6′).

20. The elastomeric bushing according to claim 13, wherein the bars (6, 6′), in the area of the link with the swell walls, have a tailored shape (13) in which, because of the exempt of the swell walls (5, 5′), the formed space between them and the bars (6, 6′) extend into the bars (6, 6′) in this area.

21. The elastomeric bushing according to claim 13, wherein an additional bypass passage is present at or in the bushing body (1, 1′), in which a blocking part is positioned, which only opens this bypass passage if a radial load of the swell cavities (4, 4′) exceeds a predetermined load maximum.

22. The elastomeric bushing according to claim 13, wherein additional bar plates are vulcanized into the bars (6, 6′) to adjust a radial stiffness performance of the bars (6, 6′).

23. The elastomeric bushing according to claim 13, wherein at least one radial nipple (14, 14′), which extends radially, is positioned in an axial central area of the swell cavities (4, 4′).

24. The elastomeric bushing according to claim 23, wherein the nipple (14, 14′) is formed as with a profile in each of the swell walls (5, 5′).
